(19) United States
(12) Patent Application Publication
(10) Pub. No.: US 2013/0166795 A1
(43) Pub. Date: Jun. 27, 2013

(54) SYSTEM AND METHOD FOR STREAMING DATA IN FLASH MEMORY APPLICATIONS

(71) Applicant: Stec, Inc., Santa Ana, CA (US)

(72) Inventors: Umang THAKKAR, San Diego, CA (US); Lun Bin Huang, San Diego, CA (US); Dillip K. Dash, San Diego, CA (US); Bhasker R. Jakka, San Diego, CA (US); Omid Nasiby, Irvine, CA (US)

(73) Assignee: STEC, Inc., Santa Ana, CA (US)

(21) Appl. No.: 13/723,111

(22) Filed: Dec. 20, 2012

Related U.S. Application Data
(60) Provisional application No. 61/580,113, filed on Dec. 23, 2011.

(51) Int. Cl. G06F 3/00; G06F 13/16

(52) U.S. Cl. CPC G06F 3/00; G06F 13/1689
USPC 710/59; 710/61

(57) ABSTRACT

Systems and methods for streaming data are disclosed. In various implementations, the system comprises a hardware device and input streaming interface operably connected to the hardware device. The input streaming interface is configured to inform a data source, based on a determination that a receiving device will accept data transmitted by the hardware device, that the input streaming interface is ready to receive data, and then receive, in response to the detecting the activation of a source signal and a data initiation signal associated with the data source, source data transmitted by the data source over a data bus, and forward the source data to the hardware device.

### CROSS-REFERENCES TO RELATED APPLICATIONS

This application claims priority from U.S. Provisional Application No. 61/580,113, entitled “STREAMING PROTOCOL FOR SSD APPLICATION” and filed Dec. 23, 2011, the subject matter of which is incorporated herein by reference in its entirety.

### BACKGROUND

The subject disclosure relates to data transfer. Particularly, the subject disclosure pertains to a streaming protocol for improving data throughput between two transfer devices.

### SUMMARY

Bandwidth maximization is desired for high speed applications, such as solid-state drives (SSD), where increasing bandwidth usage can result in greatly improved performance. The instant disclosure provides a system and method for implementing a streaming protocol that improves data throughput and provides an efficient “quality of result” (QoR). In certain aspects, the protocol implementation can be configured such that data transfer can be made to occur between either synchronous or asynchronous devices.

A system for transferring data may comprise a hardware device and an input streaming interface operably connected to the hardware device. In this implementation, the hardware device may be configured to receive data and the input streaming interface is configured to determine that a receiving device will accept data transmitted by the hardware device, activate a receiver ready signal to inform a data source that the input streaming interface is ready to receive data, detect the activation of a source signal and a data initiation signal associated with the data source, receive, in response to the detection, source data transmitted by the data source over a data bus, and forward the source data to the hardware device.

The input streaming interface may be further configured to receive an indication that the data source has completed transmission of the source data, and complete the receiving of the source data at the input streaming device on receiving the indication. In some aspects, the input streaming device may be configured to detect that the source signal has been suspended before the transmission of the source data is completed, and suspend the receiving of the source data for a period of time that the source signal remains suspended. Additionally or in the alternative, the system may further comprise output streaming interface operably connected to the hardware device and configured to determine that the receiving device will accept data transmitted by the hardware device, activating output ready signal to inform the input streaming interface that the receiving device will accept data transmitted by the hardware device, the receiver ready signal being activated based on the output ready signal, receive the source data from the hardware device, and forward the source data to the receiving device.

In further aspects, the system may further comprise output streaming interface operably connected to the data source. Accordingly, the output streaming interface may initiate a transmission of the source data from the output streaming interface to the input streaming interface over the data bus, inform the input streaming interface that the transmission has been initiated by activating the source signal and the data initiation signal, suspend the transmission of the source data for a period of time, and in conjunction with suspending the transmission, inform the input streaming interface that the transmission has been suspended by deactivating the source signal for the period of time.

In some implementations, the subject disclosure provides a method for transferring data, the method comprising on receiving a data initiation signal in conjunction with a source signal from a data source, reading source data from a data bus, and, on receiving a data completion signal from the data source after the data initiation signal, completing the reading of the source data.

In further implementations, a method for transferring data may comprise initiating a transmission of data to a receiving device, activating a source signal and a data initiation signal in connection with the initiation of the transmission of data, and transmitting the data only when a receiver ready signal is activated. The method may further comprise, transmitting a first portion of data to the receiving device, determining that the receiver ready signal has been deactivated before the transmission of the first portion of data is complete, suspending the transmission of the first portion of data until the receiver ready signal is reactivated, receiving an indication that the receiver ready signal has been reactivated, completing, on the indication, the transmission of the first portion of data, and transmitting a second portion of data to the receiving device.

Additionally or in the alternative, the method may further comprise transmitting a first portion of data to the receiving device, deactivating, after transmitting the first portion of data, the source signal to signal a suspension of the transmission of data, waiting for a period of time, transmitting, after the period of time, a subsequent portion of data to the receiving device.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 is a block diagram illustrating components of a flash memory device.

FIG. 2 illustrates a system level view of an example implementation of a streaming protocol, according to some aspects of the subject technology.

FIG. 3 illustrates a timing diagram of an example data transfer operation using the streaming protocol.

FIG. 4 illustrates an example signal timing diagram for suspending a data transfer.

FIG. 5 illustrates an example signal timing diagram for suspending a data transfer in response to sink back pressure from one or more downstream devices.

FIG. 6 illustrates a timing diagram of an example data transfer having a sink delay at the start of data transmission.

FIG. 7 is a timing diagram illustrating an example of a complete transfer of data.

FIG. 8 is a block diagram of an example architectural implementation of an input streaming hardware device.

FIG. 9 illustrates a state diagram of an example macro-architecture implementation of streaming blocks.

FIG. 10 illustrates an example system for communicating between two transfer devices using the streamer protocol of the subject technology.

FIG. 11 illustrates a timing diagram of an example data transfer between a core logic block and input and output streamer blocks.

FIG. 12 depicts a flowchart of a first example method for transferring data.

FIG. 13 depicts a flowchart of a second example method for transferring data.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology may be practiced without these specific details. In some instances, structures and components are shown in block diagram form in order to avoid obscuring the concepts of the subject technology. Like components are labeled with identical element numbers for ease of understanding.

In various implementations, the subject technology includes an output streaming interface (“output streamer interface”) and an input streaming interface (“input streamer interface”) for transferring data between hardware devices using a minimal number of signals. The subject technology further implements a protocol that facilitates a high transfer of data by efficient management of data flow. Accordingly, data is transferred between interfaces in response to specific signaling patterns between the interfaces. For example, the input streamer interface informs the output streamer that it is ready to receive data over a data bus by activating a signal. The input streamer then detects the activation of a source signal and a data initiation signal from the output streamer interface, and receives, in response to the detection, source data transmitted by the output streamer interface over a data bus, and forwards the source data to a hardware device.

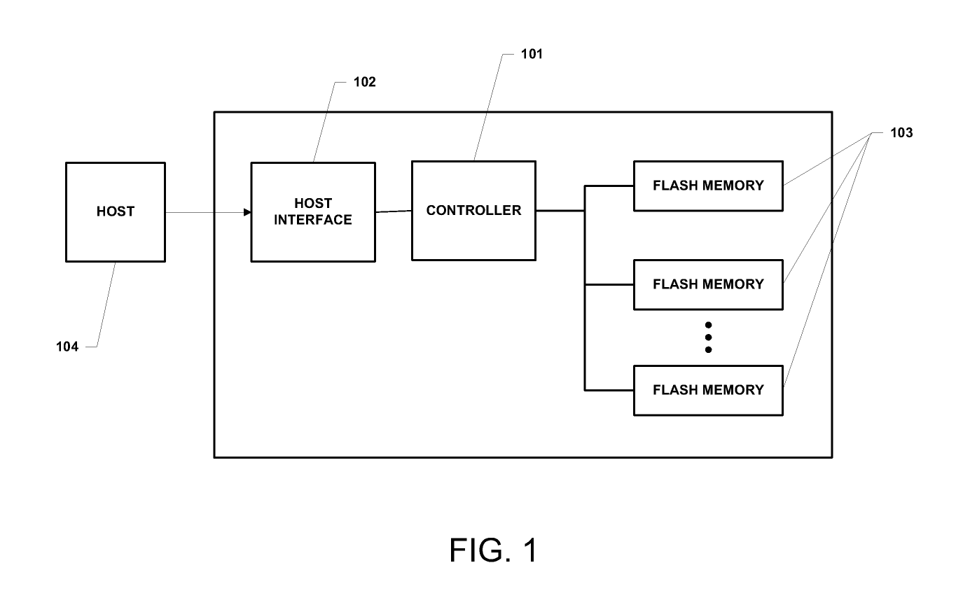

FIG. 1 is a block diagram illustrating components of a storage device 100 according to one aspect of the subject technology. Storage device 100 includes a controller 101, a host interface 102, and an array of flash memory 103. The elements of flash memory 103 may be integrated into a single chip or may be implemented in two or more discrete components.

Controller 101 may be implemented with a general-purpose microprocessor, a microcontroller, a digital signal processor (DSP), an application specific integrated circuit (ASIC), a field programmable gate array (FPGA), a programmable logic device (PLD), a controller, a state machine, gated logic, discrete hardware components, or a combination of the foregoing. One or more sequences of instructions may be stored as firmware on ROM within the controller. One or more sequences of instructions also may be software stored and read from another storage medium, such as flash memory array 103, or received from a host 104 via host interface 102. ROM, storage media, and flash memory arrays represent examples of machine or computer readable media on which instructions/code executable by the controller can be stored. Machine or computer readable media may generally refer to any medium or media used to provide instructions to controller 101, including both volatile media, such as dynamic memory used for storage media or for buffers within the controller, and non-volatile media, such as electronic media, optical media, and magnetic media.

Host interface 102 may be configured to implement a standard interface, such as Serial-Attached SCSI (SAS), Fiber Channel interface, PCI Express (PCIe), SATA, USB, and the like. The host interface may be configured to implement only one interface. Alternatively, host interface 102 may be configured to implement multiple interfaces, which are individually selectable using a configuration parameter selected by a user or programmed at the time of assembly. Host interface 102 may include one or more buffers for buffering transmissions between a host and the controller. Host 104 may be any device configured to be coupled to the data storage system and to store data in data storage system. The host may be, for example, a computing system such as a personal computer, a server, a workstation, a laptop computer, PDA, smart phone, and the like. Alternatively, the host may be an electronic device such as a digital camera, a digital audio player, a digital video recorder, and the like.

Flash memory array 103 represents non-volatile memory devices for storing data. According to one aspect of the subject technology, flash memory array 103 includes NAND flash memory. Each component of flash memory array 103 may include a single flash memory device or chip, or may include multiple flash memory devices or chips arranged in multiple channels, as depicted in FIG. 1. The flash memory is not limited to any particular capacity or configuration. For example, the number of physical blocks, the number of physical pages per physical block, the number of sectors per physical page, and the size of the sectors may vary within the scope of the subject technology.

It is desirable for storage applications to increase bandwidth utilization, transfer data in each cycle without interruptions (stalls), and have the ability to transfer a precise number of byte bursts, irrespective of the data-bus size. Bandwidth maximization is particularly useful for high speed applications (e.g., for use in SSD), where increasing bandwidth usage can result in greatly improved performance.

Implemented measures or protocols for increasing bandwidth utilization should take into consideration other aspects of hardware implementation, for example static and dynamic power considerations, area and timing. Systems that utilize many hand-shake signals and buses result in a greater amount of power dissipation and increased area. In order to increase bandwidth, and decrease latency, it may be desirable to decrease the number of signals/connections between transfer devices.

The instant disclosure provides a system and method for increasing bandwidth usage while decreasing the number of hand-shake signals and data buses between configurable (synchronous or asynchronous) transfer devices. As a result, the subject disclosure provides for improved bandwidth utilization while also improving upon area and power parameters. More specifically, the instant disclosure describes a streaming protocol that improves throughput and provides an efficient “quality of result” (QoR). In certain aspects, the protocol implementation can be configured such that data transfer can be made to occur between either synchronous or asynchronous devices.

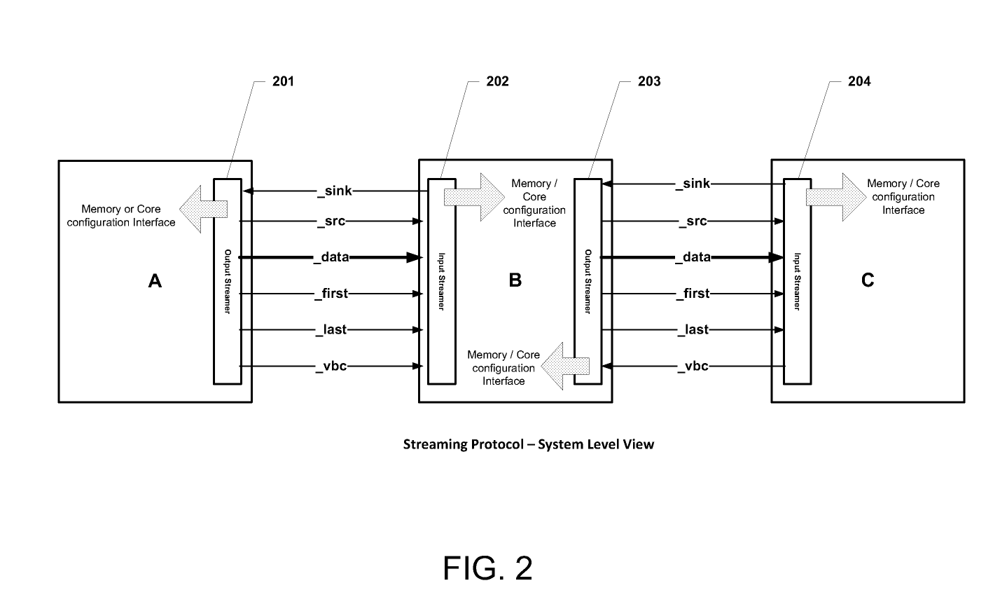

FIG. 2 illustrates a system level view of an example implementation of a streaming protocol, according to some aspects of the subject technology. In the illustrated example, multiple signals used in the streaming protocol are shown as being transferred between a hardware system block A and a hardware system block B, as well as between hardware system block B and a hardware system block C. System blocks A, B, C each include a hardware device operably connected to input and/or output streaming hardware. In some implementations, these system blocks may include various components depicted in FIG. 1. For example, the streaming protocol may be implemented between host 104 (e.g., depicted as system block A) and host interface 102 (e.g., depicted as system block B). In other implementations, the streaming protocol may be implemented between the controller 101 and one or more flash memory devices (e.g., depicted as system block C), for example, one or more memory devices in flash memory array 103.

In the depicted example, system block A may be considered a “starting block.” System block A includes an output streamer interface 201, which is internally connected to a hardware device (e.g., a memory interface or a core logic interface), and operably connected to an input streamer interface 202 of system block B. Block B is in the middle of the chain and contains both input streamer interface 202 and an output streamer interface 203. Output streamer interface 203 of system block B is connected to an input streamer interface 204 of system block C, which represents an end device in the chain.

System block A may be considered a “data source” and the input side of system block B may be considered a “receiving device” (or “sink block” or “data sink”). Similarly, the output side of system block B may be considered a data source to the input side of system block C (e.g., a downstream receiving device). In this regard, each data source may include a hardware device such as a flash memory device or other hardware device capable of receiving and/or sending data, or, as depicted by FIG. 2, an output streamer interface 201 or 203.

In certain aspects, data signals between a data source and a receiving device (e.g., between output streamer interface 201 and input streamer interface 202) include a receiver ready signal (“_sink”), a source signal (“_src”), a data bus (one or more “_data” signals), a data initiation signal (“_first”), a data completion signal (“last”), and a byte valid signal (“_vbc”).

When activated (e.g., asserted, set to a binary high, or the like) the _sink signal indicates that a receiving device can accept data from a data source. In practice, the _sink signal can be used for back pressuring data flow from the data source (e.g., system block A) to a downstream receiving device (e.g., system block C). The _src signal is activated by a data source to inform a receiving device that the data source is ready to transmit data and that all other source-to-sink signals from the data source are valid. When the _sink and _src are activated, the data bus and other source-to-sink signals (for example, _first, _last, and _vbc) are sampled by the receiving device. Otherwise these source-to-sink signals are ignored. One or more _data signals are carried via the data bus from the data source to the receiving device. In certain aspects, the width of the data bus is defined according to manufacturer or user data transfer requirements. Although any number of bytes may be potentially transferred on the data bus, in some examples the data bus only supports an integer number of bytes and does not support fractional bytes.

The _first signal is activated by the data source to inform the receiving device (e.g., input streamer interface 202 or 204) that a data transmission has been initiated. The data bus may be used to transfer one or more payloads of source data, including, for example, a block, page, or code word of data. Accordingly, activation of the _first signal may indicate the beginning of the payload. As described previously, the _src signal may inform the receiving device that the _first signal is valid. The _vbc signal provides an indication as to which bytes transmitted on the _data bus are valid for the last data sample transfer. The _vbc signal indicates the total data transfer size of data transferred in a corresponding cycle. For example, _vbc may be 4 bits wide for a 4 byte wide data bus, with each bit representative of a byte transferred on the data bus. If all 4 bytes of the data bus are used in a current data transfer then all 4 bits of _vbc may be activated. If a final transmission only requires 3 bytes to be transferred then the fourth data bit may be set to 0 to inform the receiving device that the fourth byte should not be read.

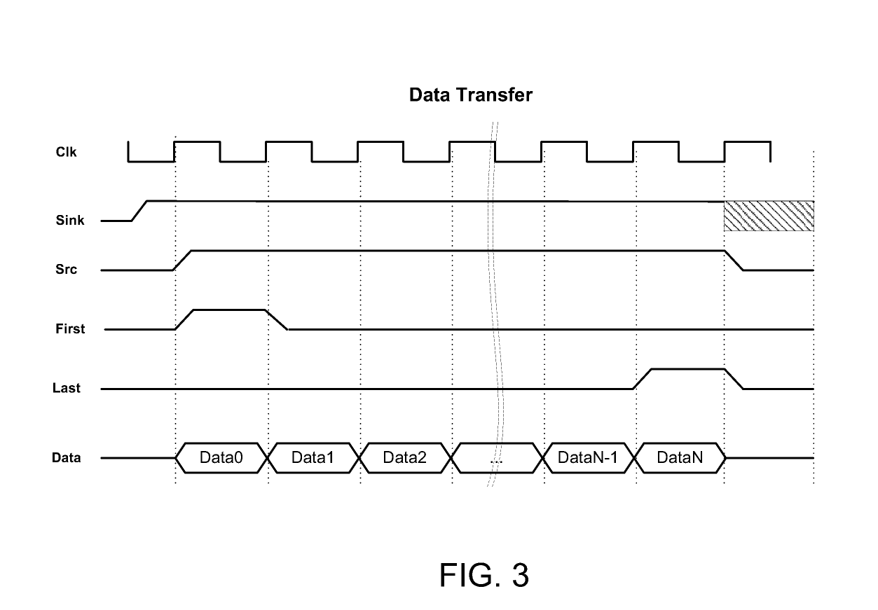

FIG. 3 illustrates a timing diagram of an example data transfer operation, according to some aspects of the subject technology. As shown in FIG. 3, when a data transfer from a data source to a receiving device is initiated the _sink signal, the _src signal and the _first signal are all high. The _sink signal indicates to the data source that the input streamer interface is ready to receive data. The _src signal indicates to the input streamer interface that the transfer signals (e.g., _first, _last, and _vbc) are valid, and that the input streamer interface should begin to receive the transfer on the _first signal being activated. After the initial packet (Data0) has been transmitted the _first signal returns to a low state. The _last signal is high when the last data transmission occurs (DataN). Subsequent to the data transfer, the _src, _first and _last signals are all deactivated (e.g., set to a low state).

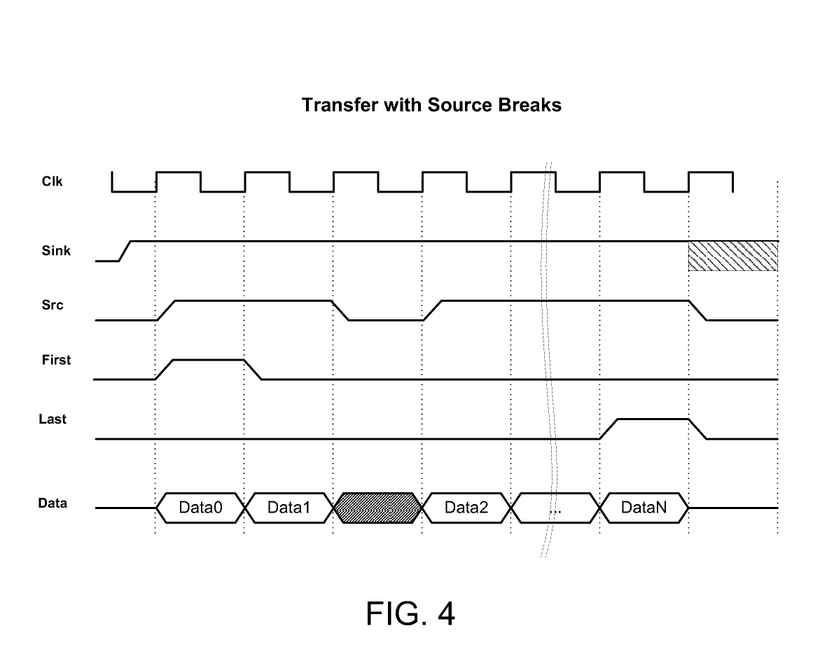

FIG. 4 illustrates an example signal timing diagram for suspending a data transfer. The subject technology enables a system to suspend data transfer with almost no signaling overhead. For example, with reference to FIG. 2, output streamer interface 201 may initiate a transmission of data to input streamer interface 202. Output streamer interface 201 activates _src and _first signals in connection with the initiation of the data transmission using one or more _data signals. Output streamer interface 201 may monitor the _sink signal to determine whether it has been activated prior to initiating the data transfer. Accordingly, output streamer interface 201 transmits source data to input streamer interface 202 only when the _sink signal is activated.

During the data transmission, output streamer interface 201 may signal the suspension of data transmission and suspend the data transmission by deactivating the _src signal. For example, output streamer interface 201 may transmit a first portion of data to input streamer interface 202 (e.g., data0 and data1 of FIG. 4). Interface 201 may then deactivate or suspend the _src signal for a period of time (e.g., one or more clock cycles). The deactivation of _src signal informs interface 202 that the data transmission has been suspended. Accordingly, interface 202 may discontinue reading the data bus. After the period of time for the suspension is passed, interface 201 reactivates the _src signal and places a subsequent portion of data on the data bus. On detecting the reactivation of the _src signal, interface 202 begins to read and receive the subsequent portion of data.

As illustrated, in the first clock cycle, wherein Data0 is transmitted, the _sink, _src and _first signals are all high. Subsequently, in the second clock cycle, wherein Data1 is transmitted, the _first signal returns to the low state. The transfer break occurs between Data1 and Data2 in the third clock cycle. During the transfer break, the _sink signal is high, while the _src and _first signals are low. After the transfer break has ended (e.g., in the fourth clock cycle wherein Data2 is transmitted), the _sink and _src signals are both high, indicating both devices are ready to send and receive data, and wherein the _first and _last signals are low, indicating that data transmission is ongoing. Data transmission concludes with the activation of the _last signal and simultaneous transmission of DataN. On completion of the transmission, the _sink, _src and _last signals are all high.

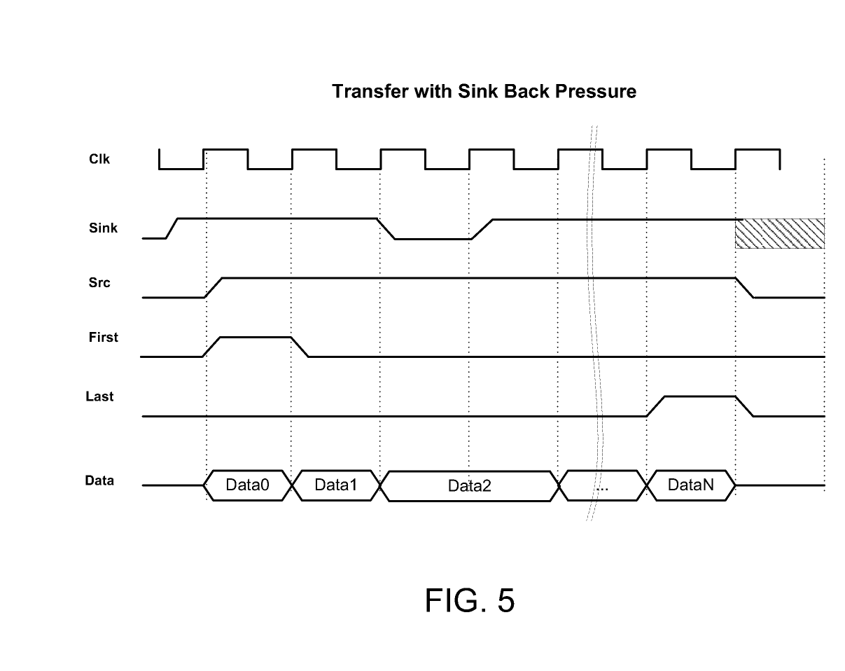

FIG. 5 illustrates an example signal timing diagram for suspending a data transfer in response to sink back pressure from one or more downstream devices, according to one aspect of the subject technology. Sink back pressure may occur when there is congestion at a receiver end. Before data can be transferred from an output streamer interface to an input streamer interface, the output streamer interface must determine that the input streamer interface will accept data. Accordingly, the output streamer interface monitors the _sink signal received from the input streaming device, and may hold a transmission of data when the _sink signal is deactivated.

For example, output streamer interface 201 may transmit a first portion of data to input streamer interface 202, and then determine that the _sink signal has been deactivated before the first portion of data is completed (e.g., accepted by input streamer interface 202). Output streamer interface 201 then suspends the transmission of the first portion of data until the _sink signal is reactivated. Suspending the transmission of the first portion may include holding the current values of the _data signals, letting them float, or the like. Concurrently, input streamer interface 202 suspends reading of the _data signals (e.g., ignores them) while the _sink signal is deactivated.

Input streamer interface 202 may have deactivated the _sink signal to suspend reading of data because a read buffer satisfied a threshold (e.g., was at capacity) or because a downstream receiving device has indicated that the device would not receive further data. Interface 202 may wait a period of time (e.g., one or more clock cycles) until it receives an indication that data flow may continue. Accordingly, interface 202 may reactivate the _sink signal after a period of time to inform output streamer interface 201 that data transmission may continue. Concurrent with reactivation of the _sink signal, input streamer interface 202 reads the first portion of data (that was previously left unread) and any subsequent portions of data placed on the _data signals in subsequent clock cycles.

As illustrated, in a first clock cycle, Data0 is transmitted, while the _sink, _src and _first signals are high and the _last signal is low. In the second clock cycle, Data1 is transmitted, and the _sink and _src signals are high and the _first and _last signals are low. The _sink signal is suspended by deactivating the signal for the third clock cycle, and reactivating the signal for the fourth clock cycle. Accordingly, Data2 is transmitted over the third and fourth clock cycles. As illustrated, in the third clock cycle, the _sink, _first and _last signals are low and the _src signal is high. In the fourth clock cycle, the _sink signal is returned to a high state. Data transmission concludes with the activation of the _last signal and simultaneous transmission of DataN. On completion of the transmission, the _sink, _src and _last signals are all high.

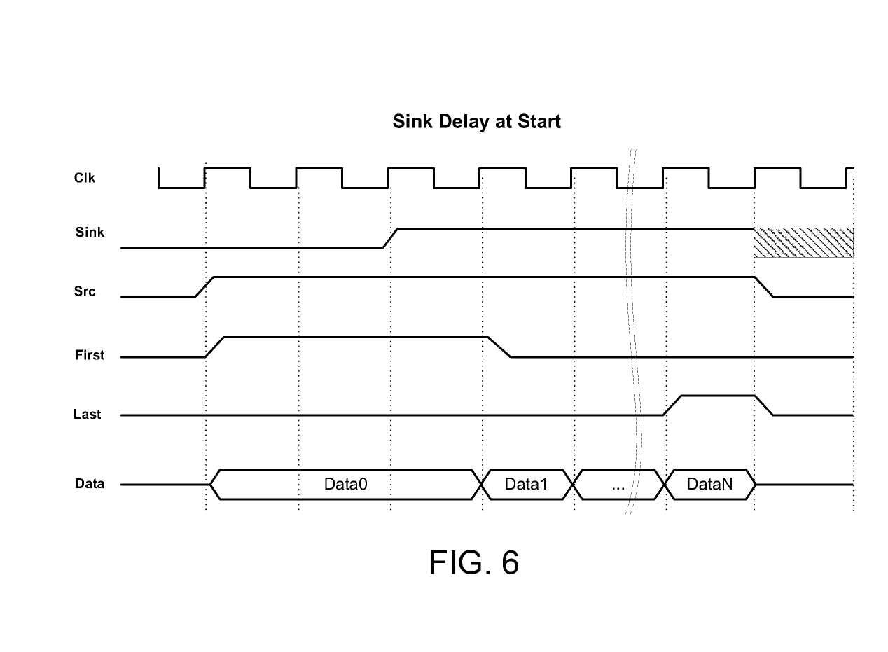

FIG. 6 illustrates a signal timing diagram of an example data transfer having a sink delay at the start of data transmission. In some aspects, a receiving device may not be ready when a data source initiates a data transmission. As illustrated, the transmission of Data0 begins in the first clock cycle and continues until the third clock cycle due to a delay in the activation of the _sink signal. In the first two clock cycles, the _sink and _last signals are low and the _src and _first signals are high. In the third clock cycle, the _sink changes to high and the data transmission begins. Accordingly, the receiving device informs the data source that the receiving device is not ready to receive data, and the data source holds the current state of the transmission of the data until the receiving device becomes ready.

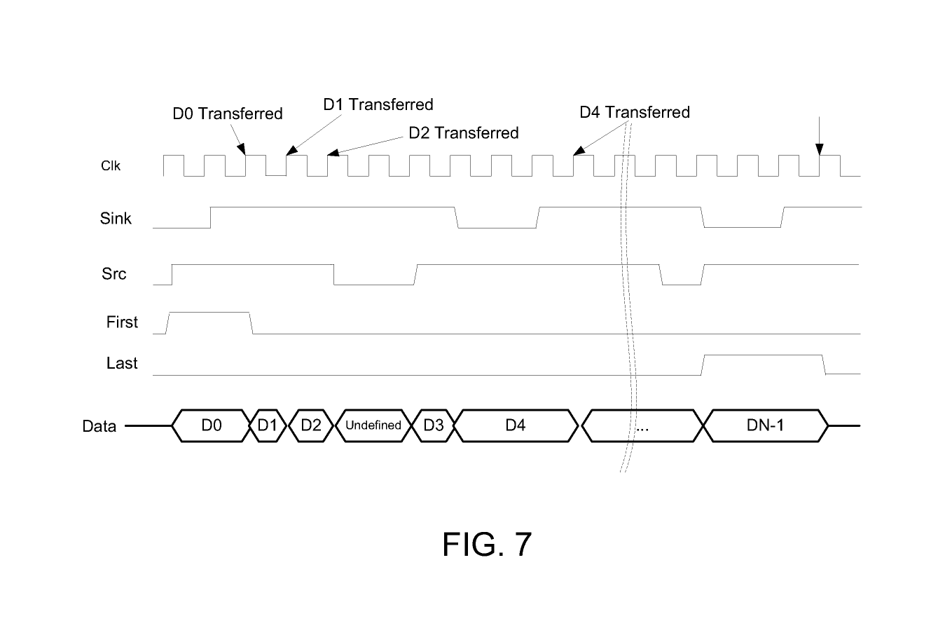

FIG. 7 is a signal timing diagram illustrating an example of a complete transfer of data, according to one aspect of the subject technology. In the depicted example, a data source (e.g., an output streamer interface) activates the _src and _first signals, and places data D0 on the data bus. D0, however, is not transferred until the receiver device (e.g., input streamer interface) activates the _sink signal on the leading edge of the second clock cycle. D1 and D2 are transferred on the two subsequent clock cycles. On the fourth clock cycle, the data source suspends the _src signal for two clock cycles, and lets the data bus signals float (i.e., no data). The suspension of the _src signal informs the receiver device that no data is being transferred for the two clock cycles that the signal is suspended. When the _src signal is reactivated D3 is transferred. One clock cycle later, the data source places D4 on the data bus. However, the receiver device deactivates the _sink signal to inform the data source that the receiver device cannot accept further data transfer. When the _sink signal is reactivated two clock cycles later, D4 is transferred.

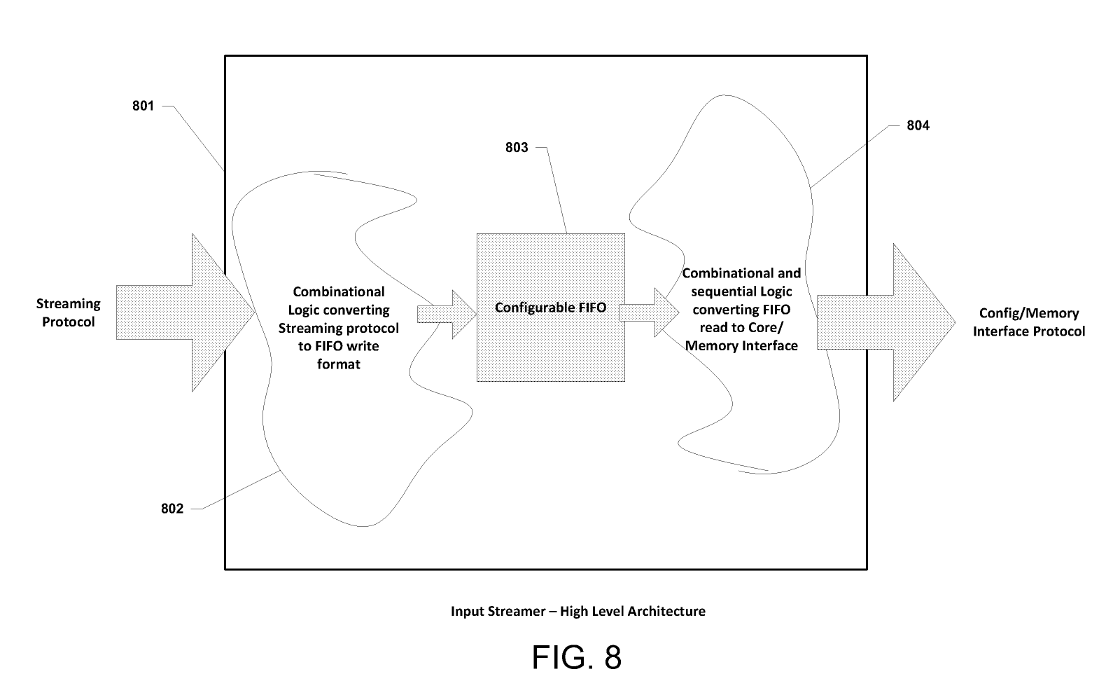

FIG. 8 is a block diagram of an example architectural implementation of an input streaming hardware component, according to one aspect of the subject technology. An input streaming hardware component 801 includes a hardware interface and logic for receiving data using a first protocol (e.g., the previously described signal protocol) and then transmitting that data using a second protocol (e.g., a memory or core interface protocol implemented by a flash memory device or other device). In the example implementation, input streaming component 801 includes combinational logic 802 that converts the information received via the first protocol to a first-in-first-out (FIFO) format. Hardware component 801 further includes a configurable FIFO buffer 803 for receiving FIFO data from logic 802 (e.g., the number of bytes that may be transferred at any one time is configurable). As data is received at hardware component 801, logic 802 converts the received data to FIFO data and stores the FIFO data in buffer 803. When buffer 803 is full the _sink (or _src) signal is deactivated (e.g., set to low).

Input streaming hardware component 801 also includes combinational and sequential logic 804 for receiving the FIFO data from buffer 803, arranging the data in a format used by the second protocol. Hardware component 801 is then configured to connect to one or more receiving devices using the second protocol, and to forward the data received from buffer 803 to the one or more receiving devices using the second protocol. In some aspects, an output streamer component may be implemented in a manner as the input streamer depicted by FIG. 8, however, the direction of the arrows would be reversed.

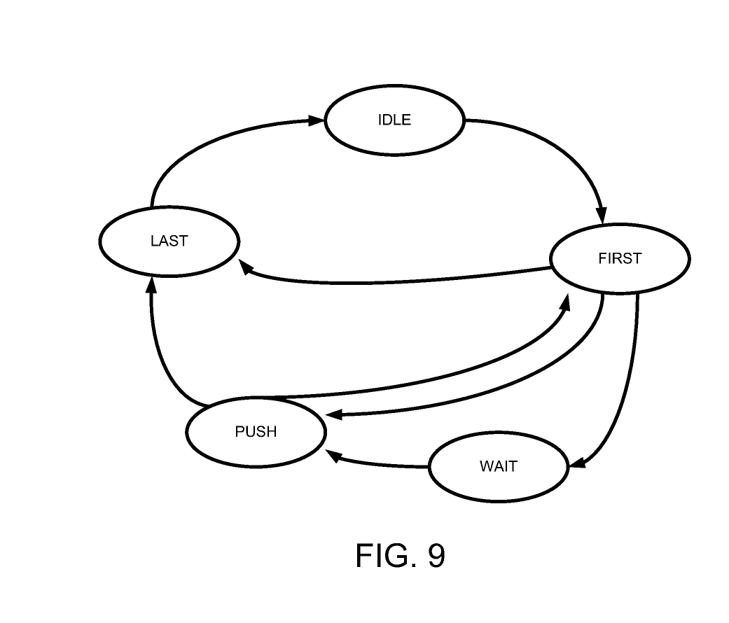

FIG. 9 illustrates a state diagram of an example macro-architecture implementation of streamer blocks, according to one aspect of the subject technology. The FIRST state arises when the _first signal is activated. The PUSH state is a condition in which the either the _sink is activated by the input streamer interface or the _src is activated by the output streamer interface. Depending on the status of the _sink and _src signals the FIRST state may come before or after the PUSH state. For example, when the _src signal is activated simultaneously with or after the _sink signal the transfer of data is “pushed” by the output streamer interface. When the _sink signal is activated after the _src signal, the input streamer interface initiates the “push” of data. The WAIT state arises while the output streamer interface has initiated the _first signal and is waiting for the _sink signal to initiate transmission of data. The LAST state arises when the _last signal is activated, ending the transmission of data. The IDLE state arises when the signals for data transmission, including the _first signal, are not activated.

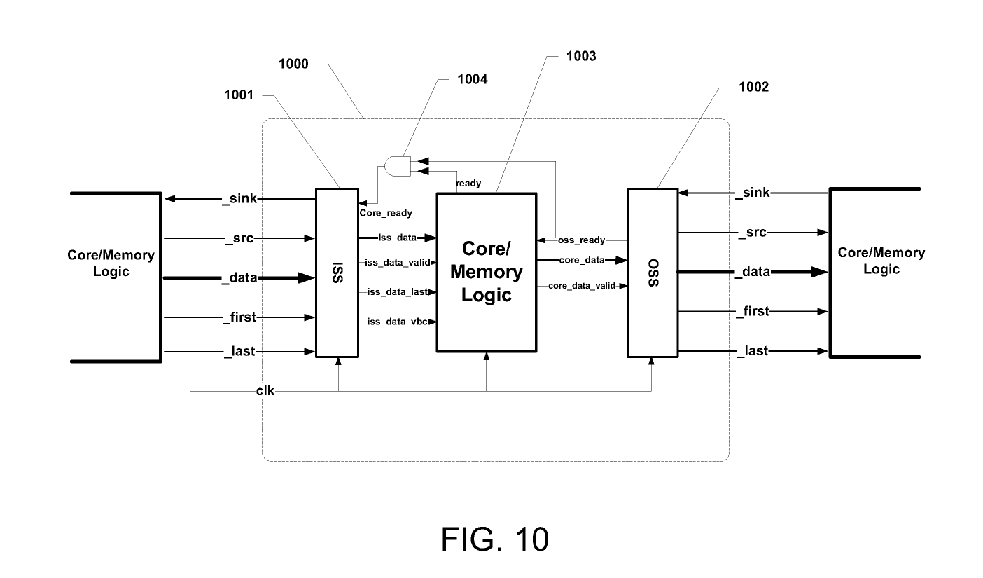

FIG. 10 illustrates an example system 1000 for communicating between two transfer devices using a streamer protocol, according to one aspect of the subject technology. System 1000 includes two transfer mechanisms that exchange data using a minimum number of signals to communicate: an input streamer (IS) block 1001 and an output streamer (OS) block 1002. IS block 1001 and OS block 1002 include the previously described input streamer interface 202 and output streamer interface 201, respectively. Accordingly, IS block 1001 accepts streamer data (source data provided in a transmission according to the protocol of the subject technology), while OS block 1002 sends source data.

System 1000 further includes a Core/Memory Logic block (“core logic block”) 1003 between the IS and OS blocks. Core logic block 1003 may include a flash memory device, processor, or other device configured to send and/or receive data to and/or from another device. In some implementations, the IS and OS streamer blocks may sit between two cores (or two memory devices). In these implementations, a determination as to which of the IS/OS blocks are used may depend upon the direction of data flow. According to various aspects of the subject technology, IS block 1001, OS block 1002, and core logic block 1003 may be implemented on multiple dies or the same die.

In the depicted example, core logic block 1003 is situated between the IS and OS blocks and interfaces with five signals at the input side and three signals at the output side. Core logic block 1003 is configured to receive and send data. When configured between IS block 1001 and OS block 1002, core logic block 1003 operates to forward data from the IS to the OS, after internally processing the input data. In this example, the IS and OS blocks do not force data movement through core logic block 1003. Instead, core logic block 1003 functions to stop and start the transfer at every clock cycle. Core logic block 1003 may have a latency that depends on the pipeline delay involved.

In some implementations, IS block 1001 is operably connected to core logic block 1003 on an input side of core logic block 1003. In one aspect, IS block 1001 is configured to determine that a receiving device will receive data transmitted by core logic block 1003. The determination may be made by detection of an output streamer ready signal provided by OS block 1002 and a core ready signal provided by core logic block 1003. The output streamer ready signal and core ready signal are provided when there is no back pressure indicated from downstream devices. In the depicted example, the output streamer ready signal and core ready signal are fed into an AND gate 1004, the output of which is read by IS block 1001 to determine that the downstream devices are ready to receive data. AND gate 1004 may be part of IS block 1001 or implemented as a separate component.

Based on the previously described determination, IS block 1001 is configured to inform a data source operably connected to IS block 1001 that the IS block is ready to receive data. IS block 1001 then monitors the data signals for the activation of a source signal and a data initiation signal. On detecting both of these signals, IS block 1001 is configured to receive source data transmitted by the data source. In some aspects, the source data is transmitted over a data bus that includes one or more of the previously described _data signals. Once received, IS block 1001 is configured to be forwarded the source data to the core logic block 1003 (e.g., over one or more of the depicted is s_data signals).

In some implementations, OS block 1002 is operably connected to core logic block 1003 on an output side of core logic block 1003. In one aspect, OS block 1002 is configured to determine that a downstream receiving device 1005 will accept data transmitted by core logic block 1003. Such determination may be made using any of the previously described techniques. OS block 1002 is further configured to inform IS block 1001 that receiving device 1005 will accept and/or receive data transmitted by the hardware device. In this regard, IS block 1001 may activate the previously described output streamer ready signal to AND gate 1004. OS block 1002 then receives the source data from core logic block 1003 in the manner previously described with reference to FIG. 8 and other examples of this disclosure. The source data may be forwarded by OS block 1002 to downstream receiving device 1005 as it becomes available.

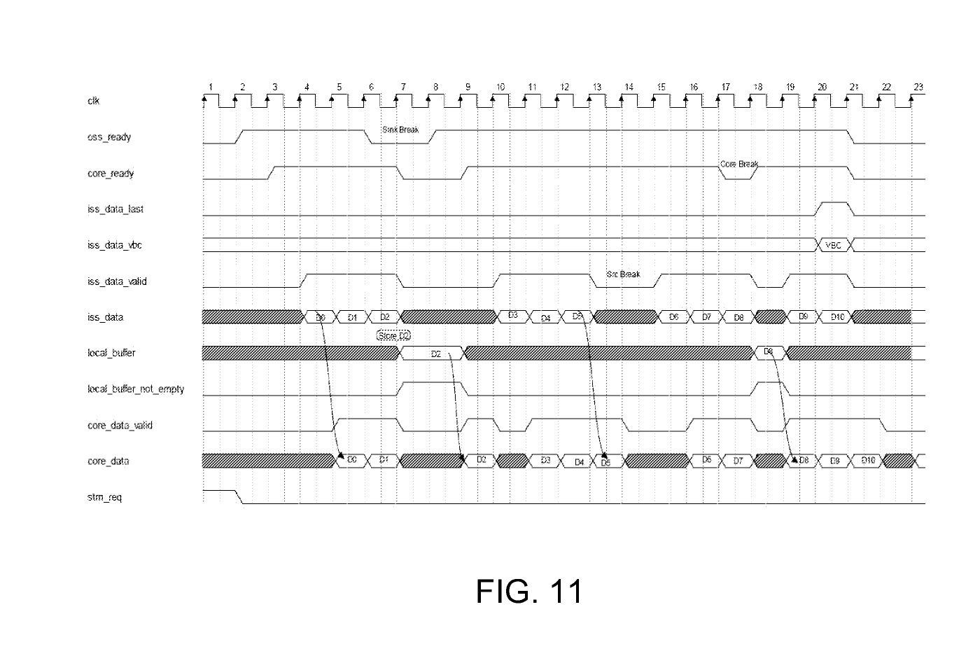

FIG. 11 illustrates a timing diagram of an example data transfer between a core logic block and input and output streamer blocks, according to one aspect of the subject technology. Core logic block 1003, for example, may have a one-cycle latency, or a latency that can endure for multiple clock cycles.

During the forth and fifth clock cycles, data D0 and D2 are transferred from IS block 1001 over an internal data bus (represented by iss_data) to a buffer of core logic block 1003 (represented by core_data). IS block 1001 is signaled on the sixth clock cycle that OS block 1002 is not ready to receive data, by the oss_ready signal falling to low. Accordingly, on the seventh cycle, IS block 1001 stores the current data D2 on the data bus to a local buffer. In implementations such as that of the depicted example, signaling between adjacent components in a chain may take one or more clock cycles to propagate. For example, AND gate 1004 receives, on the sixth clock cycle, an indication (via the oss_ready signal) that OS block 1002 is not ready to receive data. On the seventh clock cycle that indication is communicated to IS block 1001 via the core_ready signal. In this example, core logic block 1003 is one cycle behind OS block 1002. After a two-cycle delay, on the ninth cycle, IS block 1001 transfers the data stored in its local buffer to core logic block 1003.

The objective is to drive a core_ready signal high to get a next data sample from the IS block when core logic block 1003 and OS block 1002 are ready to receive a new sample. The input signal iss_data_valid is used in some implementations to drive a data pipeline of core logic block 1003 for simplicity, but it is not mandatory and user can choose his/her own method of operation.

In the previously described example, issues may arise when OS block 1002 experiences back pressure (e.g., when the _sink signal goes low) or when core logic block 1003 is busy and unable to accept new input data. The first situation is depicted in the “Sink Break” waveforms illustrated in FIG. 10, where the oss_ready signal from OS block 1002 is low for two clock cycles. According to the protocol of the subject technology, this state reflects the situation where OS block 1002 cannot accept new data samples. OS block 1002, however, may accept one more data samples after the oss_ready signal goes low for easy logic implementation in core logic block 1003. However, IS block 1001 will push another data sample to core logic block 1003 at the next clock cycle. IS block 1001 samples the core_ready signal in the next clock cycle to determine whether it may send further data. When core logic block 1003 can no longer send the data to OS block 1002, core logic block 1003 stores the data in a local buffer and raises a flag called local_buffer_is_not_empty. The next time the oss_ready signal goes high, the first sample sent to the OS block is the data from the local buffer and the flag will be cleared. This is followed by a new sample from the IS block. This logic simplifies the storage of core logic block 1003 and avoids its own FIFO implementation.

If the _src signal from IS block 1001 goes low, then the iss_data_valid signal will also go low after a few clock cycles. In this situation, the _src signal breaks and core logic block 1003 simply wait for the iss_data_valid signal to go high. When core logic block 1003 needs additional cycles and cannot accept new input data, then it will drive the core_ready signal low and store a next sample in the local buffer. This local buffer is used to immediately send the sample to the OS block when core logic block 1003 is ready.

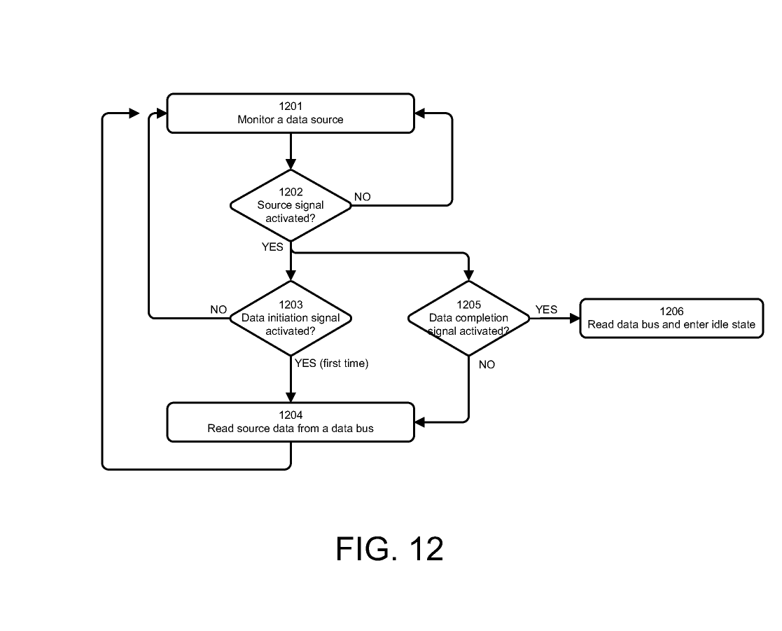

FIG. 12 depicts a flowchart of a first example method for transferring data (e.g., by data streaming), according to one aspect of the subject technology. The first example method may be implemented, for example, by the previously described input streamer interface. In block 1201, one or more signals provided from a data source (e.g., an output streamer interface 201) are monitored by the input streamer interface. Block 1202 determines whether a source signal has been detected before determining the status of other signals. For example, on receiving the source signal, the data source is monitored for a data initiation signal in block 1203. Otherwise, the process moves back to block 1201 for further monitoring of the data source.

Block 1203 determines whether a data initiation signal has been detected. The data initiation signal indicates that a data transfer is underway. Until the initiation signal is detected, the input streamer continues to monitor the data source. The data initiation signal may be a pulse signal wherein the signal is activated only for a brief amount of time (e.g., one clock cycle), after which detection of the data initiation signal is no longer required. In block 1204, on receiving the data initiation signal in conjunction with the source signal, source data is read from a data bus. In the depicted example of FIG. 12, the data initiation signal is only received when activated for the first time. In block 1205, after receiving the (first) data initiation signal, the data source is monitored for a data completion signal. The data completion signal indicates that the data transfer is completed. On receiving the data completion signal, in block 1206, the reading of the source data is completed (e.g., the source data remaining on the data bus is read and received by the input streamer interface, and the hardware placed in an idle state (e.g., standby mode). In some aspects, the data source data may be then forwarded to a downstream device.

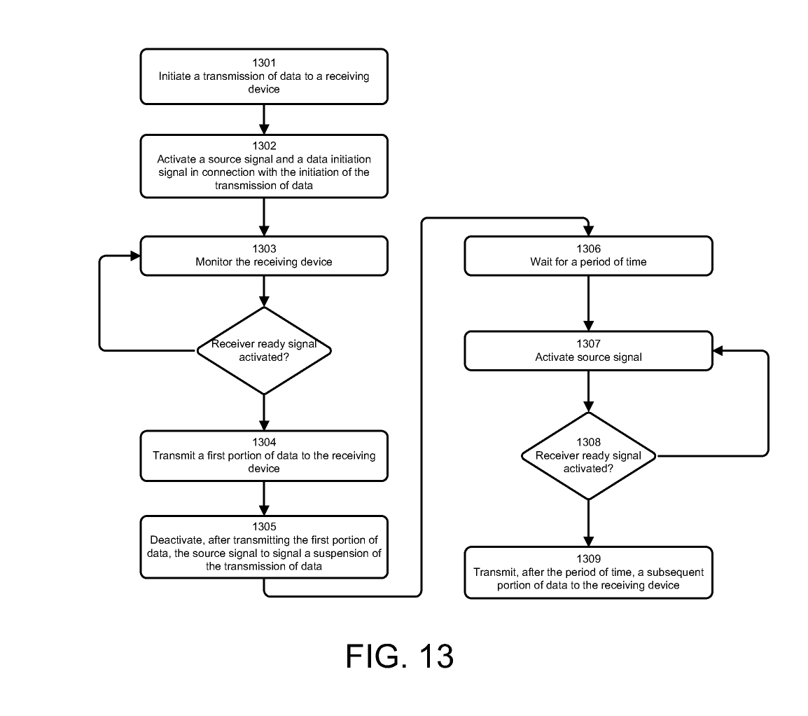

FIG. 13 depicts a flowchart of a second example method for transferring data, according to one aspect of the subject technology. The second example method may be implemented, for example, by the previously described output streamer interface. In block 1301, a transmission of data to a receiving device is initiated. In block 1302, a source signal and a data initiation signal are activated in connection with the initiation of the transmission of data. In block 1303, the receiving device is monitored for a receiver ready signal. On receiving the receiver ready signal from the receiving device, the data is placed on the data bus for transmission. In block 1304, a first portion of data is transmitted to the receiving device. In block 1305, after transmitting the first portion of data, the source signal is deactivated to signal a suspension of the transmission of data. In block 1306, the method waits for a period of time (e.g., one or more clock cycles). After the period of time, in block 1307, the source signal is reactivated. If, in block 1308, the receiver ready signal is still activated then a subsequent portion of data is placed on the data bus for transmission to the receiving device in block 1309.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is presented as an illustration of some exemplary approaches. Based upon design preferences and/or other considerations, it is understood that the specific order or hierarchy of steps in the processes can be rearranged. For example, in some implementations some of the steps can be performed simultaneously.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Pronouns in the masculine (e.g., his) include the feminine and neuter gender (e.g., her and its) and vice versa. Headings and subheadings, if any, are used for convenience only and do not limit the invention.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

What is claimed is:

1. A system for transferring data, the system comprising:
a hardware device; and
an input streaming interface operably connected to the hardware device and configured to:
activate a receiver ready signal to inform a data source that the input streaming interface is ready to receive data;
detect the activation of a source signal and a data initiation signal associated with the data source;
receive, in response to the detection, source data transmitted by the data source over a data bus; and
forward the source data to the hardware device.

2. The system of claim 1, wherein the input streaming interface is further configured to:
receive an indication that the data source has completed transmission of the source data; and
complete the receiving of the source data at the input streaming interface on receiving the indication.

3. The system of claim 1, wherein the input streaming interface is further configured to:
detect that the source signal has been suspended before the transmission of the source data is completed; and
suspend the receiving of the source data for a period of time that the source signal remains suspended.

4. The system of claim 3, wherein the input streaming interface is further configured to:
resume the receiving of the source data when the source signal is no longer suspended, wherein the source data transmitted before and after the suspension is contiguous without any loss of data.

5. The system of claim 3, wherein the period of time comprises one or more clock cycles.

6. The system of claim 1, wherein the hardware device is a flash memory device.

7. The system of claim 1, wherein the source data is forwarded to the hardware device when the hardware device is ready to receive data.

8. The system of claim 1, further comprising:
an output streaming interface operably connected to the hardware device and configured to:
determine that a receiving device will accept data transmitted by the hardware device;
activating an output ready signal to inform the input streaming interface that the receiving device will accept data transmitted by the hardware device, the receiver ready signal being activated based on the output ready signal;
receive the source data from the hardware device; and
forward the source data to the receiving device.

9. The system of claim 1, further comprising:
output streaming interface operably connected to the data source and configured to:
initiate a transmission of the source data from the output streaming interface to the input streaming interface over the data bus;
activate the source signal and the data initiation signal to inform the input streaming interface that the transmission has been initiated;
suspend the transmission of the source data for a period of time; and
in conjunction with suspending the transmission, deactivate the source signal for the period of time to inform the input streaming interface that the transmission has been suspended.

10. The system of claim 9, wherein suspending the transmission of the source data includes maintaining current transmission levels on the data bus for the period of time during the suspension.

11. A method for transferring data, the method comprising:
on receiving a data initiation signal in conjunction with a source signal from a data source, reading source data from a data bus; and
on receiving a data completion signal from the data source after the data initiation signal, completing the reading of the source data.

12. The method of claim 11, further comprising:
transmitting a receiver ready signal to the data source to inform the data source that a hardware device is ready to receive data before receiving the data initiation signal and reading the source data.

13. The method of claim 12, further comprising:
suspending the receiver ready signal for a period of time;
suspending the reading of the source data in connection with the suspending of the receiver ready signal; and
resuming the reading of the data after the period of time, wherein data read after the resuming is continuous from data read before the suspending.

14. The method of claim 13, wherein the period of time comprises one or more clock cycles.

15. The method of claim 12, wherein the receiver ready signal is transmitted when a receiving device is ready to receive data.

16. The method of claim 11, further comprising:
forwarding the source data to a receiving device.

17. The method of claim 11, further comprising:
receiving an indication that the source signal has terminated;
on receiving the indication, suspending the reading of the source data.

18. The method of claim 11, further comprising:
determining that the source signal has been suspended before the transmission of the source data is completed; and
suspending the reading of the source data for a period of time that the source signal remains suspended,
resuming the reading of the source data when the source signal is no longer suspended, wherein the source data is transmitted before and after the suspension without any loss in the continuity of data.

19. A method for transferring data, the method comprising:
initiating a transmission of data to a receiving device;
activating a source signal and a data initiation signal in connection with the initiation of the transmission of data; and
transmitting the data only when a receiver ready signal is activated.

20. The method of claim 19, further comprising:
transmitting a first portion of data to the receiving device;
determining that the receiver ready signal has been deactivated before the transmission of the first portion of data is complete;
suspending the transmission of the first portion of data until the receiver ready signal is reactivated;
receiving an indication that the receiver ready signal has been reactivated;
completing, on the indication, the transmission of the first portion of data; and
transmitting a second portion of data to the receiving device.

21. The method of claim 19, further comprising:
transmitting a first portion of data to the receiving device;
deactivating, after transmitting the first portion of data, the source signal to signal a suspension of the transmission of data;
waiting for a period of time;
transmitting, after the period of time, a subsequent portion of data to the receiving device.

22. The method of claim 19, further comprising:
activating a data completion signal in conjunction with completing the transmission of the data to signal the receiving device that the transmission of data is complete.
